(19) United States
(12) Patent Application Publication
(10) Pub. No.: US 2021/0256509 A1
(43) Pub. Date: Aug. 19, 2021

(54) PLANNING CURRENCY EXCHANGE TRANSACTIONS BASED ON INTERNATIONAL TRAVEL BUDGETING INFORMATION

(71) Applicant: Capital One Services, LLC, McLean, VA (US)

(72) Inventors: Latika GULATI, Annandale, VA (US); David YUN, Vienna, VA (US); Alexandra COLEVAS, Arlington, VA (US); Abdelkader M'Hamed BENKREIRA, Washington, DC (US); Michael SAIA, New York, NY (US)

(73) Assignee: Capital One Services, LLC, McLean, VA (US)

(21) Appl. No.: 16/791,516

(22) Filed: Feb. 14, 2020

(51) Int. Cl. G06Q 20/38

(52) U.S. Cl. CPC G06Q 20/381

(57) ABSTRACT

Various embodiments may be generally directed to techniques for planning currency exchange transactions based on customer-provided budgeting information associated with international travel. In some embodiments, an apparatus may comprise a network interface and processing circuitry coupled to the network interface, and the processing circuitry may be operative to forecast future requirements for one or more currencies based on travel budgeting information associated with scheduled international travel. In an example embodiment, the processing circuitry may receive travel budgeting information indicating one or more budgeted amounts of a first currency, determine a marginal currency requirement projection for a second currency based on the one or more budgeted amounts of the first currency, and update a currency requirement forecast for the second currency based on the marginal currency requirement projection. The embodiments are not limited in this context.

### TECHNICAL FIELD

Embodiments described herein generally relate to the planning and implementation of currency exchange transactions.

### BACKGROUND

As customers of a consumer credit provider draw from provided lines of credit in order to provide point-of-sale payments to retailers, merchants, and/or other entities, the consumer credit provider may be responsible for arranging for the delivery of funds to such payees. In cases in which funds are to be delivered in the form of currencies other than that in terms of which such lines of credit are denominated, the consumer credit provider may initiate currency exchange transactions in order to enable acquisition of required amounts of such other currencies. According to one approach, the consumer credit provider may directly participate in such currency exchange transactions. According to another approach, the consumer credit provider may engage in currency exchange via one or more intermediaries.

### SUMMARY

Various embodiments may be generally directed to techniques for planning currency exchange transactions based on customer-provided budgeting information associated with international travel. In some embodiments, an apparatus may comprise a network interface and processing circuitry coupled to the network interface, and the processing circuitry may be operative to forecast future requirements for one or more currencies based on travel budgeting information associated with scheduled international travel. In an example embodiment, the processing circuitry may receive travel budgeting information indicating one or more budgeted amounts of a first currency, determine a marginal currency requirement projection for a second currency based on the one or more budgeted amounts of the first currency, and update a currency requirement forecast for the second currency based on the marginal currency requirement projection. The embodiments are not limited in this context.

### BRIEF DESCRIPTION OF THE DRAWINGS

FIG. 1 illustrates an example of a first operating environment.

FIG. 2 illustrates an example of a second operating environment.

FIG. 3 illustrates an example of a third operating environment.

FIG. 4 illustrates an example of a fourth operating environment.

FIG. 5 illustrates an example of a first logic flow

FIG. 6 illustrates an example of a second logic flow.

FIG. 7 illustrates an example of a storage medium.

FIG. 8 illustrates an example of a computing architecture.

FIG. 9 illustrates an example of a communications architecture.

FIG. 10 illustrates an example of a machine-learning processing flow.

### DETAILED DESCRIPTION

Various embodiments may comprise one or more elements. An element may comprise any structure arranged to perform certain operations. Each element may be implemented as hardware, software, or any combination thereof, as desired for a given set of design parameters or performance constraints. Although an embodiment may be described with a limited number of elements in a certain topology by way of example, the embodiment may include more or fewer elements in alternate topologies as desired for a given implementation. It is worthy to note that any reference to “one embodiment” or “an embodiment” means that a particular feature, structure, or characteristic described in connection with the embodiment is included in at least one embodiment. The appearances of the phrases “in one embodiment,” “in some embodiments,” and “in various embodiments” in various places in the specification are not necessarily all referring to the same embodiment.

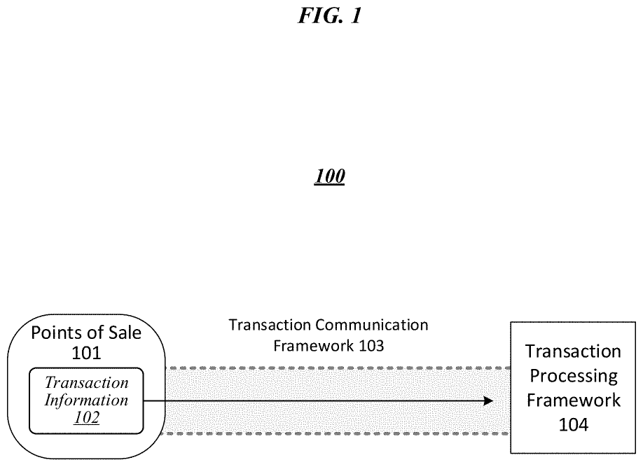

FIG. 1 illustrates an operating environment 100 that may be representative of various embodiments. In operating environment 100, a credit provider may provide a customer with a line of credit, from which that customer can borrow money in order to provide payment for goods and/or services. For example, the credit provider may issue a credit card to the customer, and the customer may draw on the line of credit by presenting the credit card to merchants as the form of payment of goods and/or services purchased therefrom. When the customer uses the line of credit to provide a payment to a given merchant, the credit provider may be responsible for remunerating the merchant for the amount of the payment, while the customer may be responsible for reimbursing the credit provider.

Customers of the credit provider may use provided credit to make payments at various points of sale 101. Some points of sale 101 may correspond, for example, to locations of in-person (“bricks and mortar”) retailers, online retailers, telephone retailers, etc. Some points of sale 101 may correspond to locations of other types of entities that accept credit-based payments, such as charities, government entities, utilities, etc. The embodiments are not limited to these examples.

As credit-based payments are made at points of sale 101, transaction information 102 may be generated in order to memorialize such payments. Transaction information 102 may include information identifying the payee, information identifying the amount of the payment, and information—such as an account number—identifying the payer. The credit provider may use a transaction processing framework 104 to process transaction information 102 in conjunction with operations associated with delivering funds to payees and debiting customer accounts in response to customer purchases. Transaction processing framework 104 may receive transaction information 102 via a transaction communication framework 103.

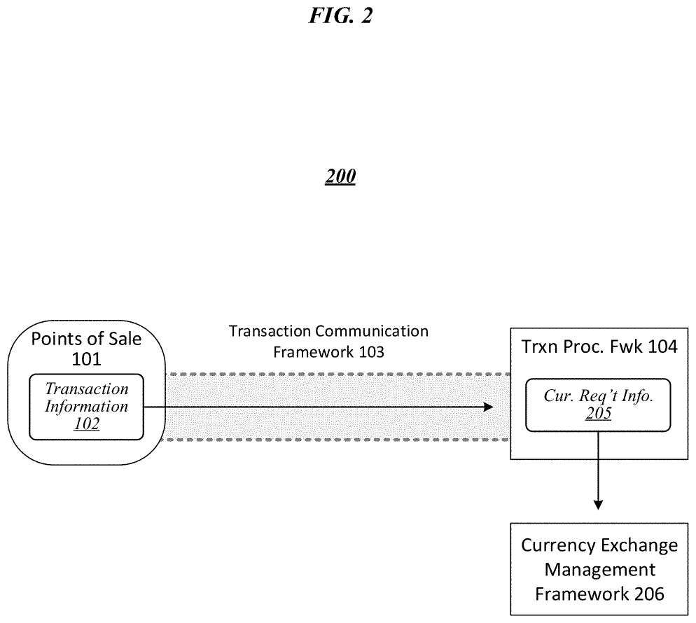

FIG. 2 illustrates an operating environment 200 that may be representative of some embodiments. In operating environment 200, some of transaction information 102 may be associated with transactions according to which the payee is paid in a foreign currency—that is, a currency different than that borrowed by the customer making use of the credit. In an example of such a transaction, a customer may use a credit card to draw on a line of credit in the form of US Dollars to provide payment to a retailer in the form of Euros. Foreign currencies needed for use in remunerating payees may be obtained via currency exchange. A currency exchange management framework 206 may generally be operative to manage currency exchange operations of the credit provider. In some embodiments, the credit provider may participate in currency exchange directly, while in other embodiments, the credit provider may engage in currency exchange via one or more intermediaries. Transaction processing framework 104 may provide currency exchange management framework 206 with currency requirement information 205 that is generally descriptive of currency needs associated with transactions processed by transaction processing framework 104. Based on currency requirement information 205, currency exchange management framework 206 may identify the required amounts of various currencies and initiate currency exchange operations accordingly.

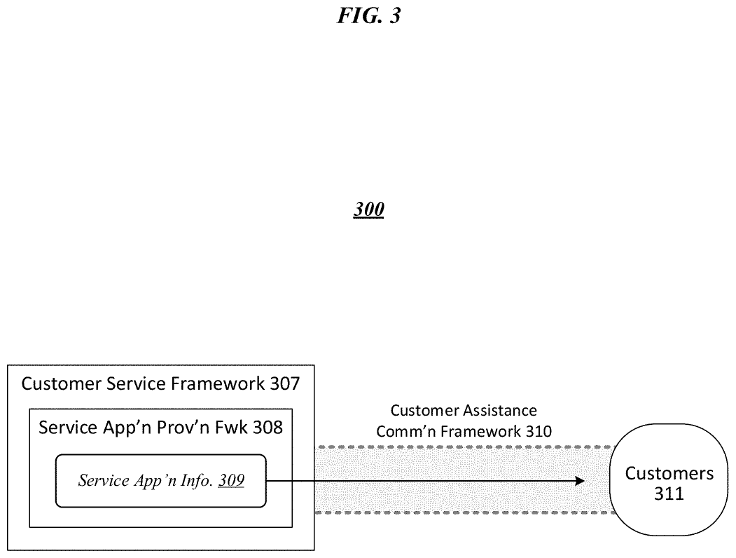

FIG. 3 illustrates an operating environment 300 that may be representative of various embodiments. In operating environment 300, a credit provider may use capabilities and/or features of a customer service framework 307 in conjunction with providing various types of customer service to customers 311. In conjunction with the provision of such customer service, communications may be exchanged between customer service framework 307 and customers 311 via a customer assistance communication framework 310. Customer service framework 307 may include a service application provision framework 308. Capabilities and/or features of service application provision framework 308 may be used to support the functionality of one or more customer service applications made available to customers 311. For example, capabilities and/or features of service application provision framework 308 may support the functionality of a mobile application that can be used by customers 311 to obtain account information, make payments, report issues, and/or perform other tasks via their mobile devices. In conjunction with the use of customer service applications by customers 311, service application provision framework 308 may generate service application information 309, which may be provided to customers 311 via customer assistance communication framework 310.

Disclosed herein are techniques according to which currency exchange operations such as may be performed by currency exchange management framework 206 of FIG. 2 may be planned based on customer-provided information such as may be received from customers 311 via customer assistance communication framework 310 of FIG. 3. According to some such techniques, based on a determination that a customer appears to be planning an international trip, that customer may be invited to utilize a travel budgeting application in order to manage a budget for that international trip. In conjunction with using the travel budgeting application, the customer may provide budgeting information indicating estimated expenditures in one or more locales. Marginal required amounts of currencies used in such locales may be projected based on such estimates, and those projections may be used to create or update currency requirement forecasts for the associated currencies. In turn, currency exchange planning may be conducted based on such currency requirement forecasts. In some embodiments, the service application provision framework 308 may provide estimated expenditure(s) based on the customer-provided information and historical data, e.g., historical expenditures from other trips.

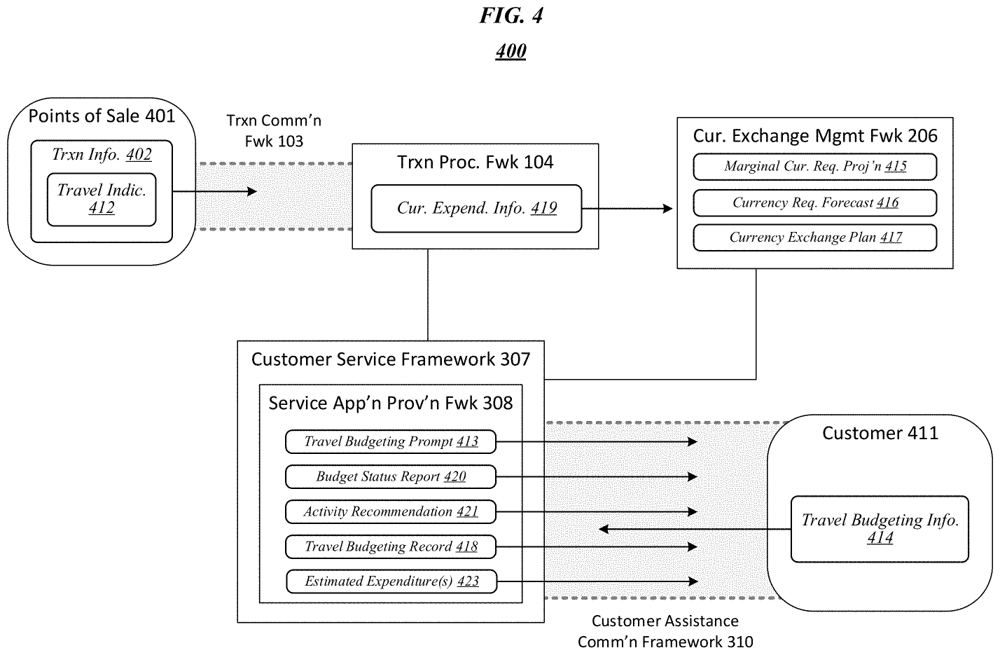

FIG. 4 illustrates an operating environment 400 that may be representative of the implementation of one or more of the disclosed techniques according to various embodiments. In operating environment 400, a customer 411 may book transportation and lodgings for an international trip and may pay using credit associated with a customer account. Transaction processing framework 104 may process transaction information 402 associated with these bookings. Based on one or more travel indications 412 comprised in transaction information 402, transaction processing framework 104 may detect scheduled international travel associated with the customer account of customer 411. A given travel indication 412 may generally comprise information indicating that transaction information 402 corresponds to credit-based payment transactions that may be reflective of customer 411 making arrangements for international travel. In one example, a given travel indication 412 may comprise information indicating that a credit-based payment transaction involves the purchase of airline tickets to a foreign destination. In another example, a given travel indication 412 may comprise information indicating that a credit-based payment transaction involves the reservation of a hotel room in a foreign city. The embodiments are not limited to these examples.

In response to the detection of the scheduled international travel, service application provision framework 308 may generate a travel budgeting prompt 413 for the customer account. Travel budgeting prompt 413 may generally represent a prompt/invitation for customer 411 to utilize a travel budgeting application in order to manage a budget for the international trip. For example, if customer 411 has installed the travel budgeting application on his/her mobile device, travel budgeting prompt 413 may take the form of a pop-up window or other prompt presented within the travel budgeting application. In another example, if customer 411 has not yet installed the travel budgeting application, travel budgeting prompt 413 may represent an invitation—in a form such as an email, text message, or other communication—to install the travel budgeting application and use it to manage the budget for the international trip. In conjunction with customer 411's use of the travel budgeting application to manage the budget for the international trip, service application provision framework 308 may be provided with travel budgeting information 414. Travel budgeting information 414 may indicate estimated expenditures in one or more locales to be visited during the international trip. In some embodiments, the service application provision framework 308 may determine one or more estimated expenditure(s) 423 for the customer 411. For example, the service application provision framework 308 may determine estimate expenditure(s) 423 for the customer 411 based on historical data, e.g., expenditures consumed by previous customers or other travelers. In one example, the service application provision framework 308 may calculate the one or more estimated expenditure(s) 423 by determining expenditures of customers/travelers that have taken similar trips. A similar trip to the one currently being planned may be considered one to the same location, traveled at the same time of year, having a same or similar length, having a same or similar type of trip (cruise vs. road trip vs. skiing trip, etc.), and so forth.

In some embodiment, the service application provision framework 308 may consider other factors when determining historical data for use in calculating the estimated expenditure(s) 423. For example, the service application provision framework 308 may generate a profile of the customer 411 and select historical data from previous customers/travelers having a similar or same profile. The profile may include factors such as, residence or location where the customer lives, the customer's income, the customer's mortgage and/or home value, car payment or car value, occupation, family size, family member's ages, previous trip expenditures, and so forth. These factors may be used to select previous customers/travelers having a similar profile to determine the estimated expenditures, for example. The service application provision framework 308 may provide the estimated expenditure(s) 423 in a number of different formats. For example, the service application provision framework 308 may provide the customer 411 with an estimated expenditure for the entire trip, as an average daily expenditure, expenditures on a per item basis, and so forth.

The service application provision framework 308 may also utilize one or more machine-learning techniques to determine the estimated expenditure(s) 423. For example, the service application provision framework 308 may utilize a machine-learning operation to train a model with historical data based on previous customer and/or travelers. As previously mentioned, the historical data may include information such as, length of travel, date of travel, the location of travel, type of travel and so forth. The historical data may also include the profile of the previous customer/traveler. This information may be feed into the model to train the model to predict future expenditures. In some instances, a clustering technique may be utilized when training the model. For example, a clustering algorithm may be applied to cluster or group previous customers/travelers based on their profiles. Clustering may provide for more accurate results when determining the estimated expenditures 423 based on the customer 411's profile. The customer 411 may utilize the estimated expenditure(s) 423 when coming up with their own expenditure estimates.

Customer 411 may provide—and travel budgeting information 414 may indicate—such estimates in terms of the currency that customer 411 borrows when drawing on the line of credit provided by the credit provider. Hereinafter, the term “borrowed currency” is employed to denote the currency that a customer, such as customer 411, borrows when drawing on a line of credit provided by the credit provider. In some embodiments, the borrowed currency may be US Dollars, and travel budgeting information 414 may indicate one or more budgeted amounts of US Dollars. The embodiments are not limited to this example.

Based on travel budgeting information 414 indicating estimated expenditures in terms of one currency, such as the borrowed currency, currency exchange management framework 206 may determine marginal currency requirement projections 415 for one or more other currencies. Each of the one or more other currencies may constitute a currency used in one or more locales to be visited during the international trip. Hereinafter, the term “expended currency” is employed to denote such a currency. The marginal currency requirement projection 415 for a given expended currency may generally indicate a projected amount of that expended currency that will need to be provided to merchants and/or other payees over the course of the international trip.

Based on a marginal currency requirement projection 415 for a given expended currency, currency exchange management framework 206 may update a currency requirement forecast 416 for that currency. The currency requirement forecast 416 for a given currency may generally constitute a forecast, over some period of time, of the amounts of that currency that will be needed to satisfy the collective payment obligations of the credit provider across its customer base, with respect to that currency. For example, a given currency requirement forecast 416 may constitute a forecast of amounts of Euros needed over the course of a three-month time period in order to satisfy the credit provider's collective payment obligations with respect to Euros. The embodiments are not limited to this example.

In some embodiments, currency exchange management framework 206 may formulate a currency exchange plan 417 based on currency requirement forecasts 416 for one or more currencies. Currency exchange plan 417 may generally define a set of one or more currency exchange transactions to be performed in order to obtain required amounts of one or more currencies. Any given one of such currency exchange transactions may involve trading some amount of one currency for some amount of another currency. In some embodiments, the one or more currency exchange transactions defined by currency exchange plan 417 may include one or more currency exchange transactions that involve trading the borrowed currency for another currency. In some embodiments, the one or more currency exchange transactions defined by currency exchange plan 417 may additionally or include one or more currency exchange transactions that involve trading one currency other than the borrowed currency for another currency other than the borrowed currency.

Following receipt of travel budgeting information 414 associated with the international trip planned by customer 411, service application provision framework 308 may create a travel budgeting record 418 associated with that international trip. Travel budgeting record 418 may comprise information indicating the estimated expenditures indicated in travel budgeting information 414. Travel budgeting record 418 may also comprise information indicating actual amounts of currencies expended during the international trip. Prior to the start of the international trip, travel budgeting record 418 may indicate that no actual currency expenditures have yet occurred. Over the course of the international trip, travel budgeting record 418 may be updated in order to reflect actual currency expenditures associated with the customer account. In some embodiments, when customer 411 draws on the line of credit in order to provide a payment during the international trip, transaction processing framework 104 may generate currency expenditure information 419 and pass it to currency exchange management framework 206. Currency expenditure information 419 may identify the expended currency and the amount of that currency that has been expended. Currency exchange management framework 206 may determine an amount of the borrowed currency that corresponds to the expended amount of the expended currency. Travel budgeting record 418 may then be updated to reflect expenditures of the borrowed currency in the determined amount.

Over the course of the international trip, service application provision framework 308 may send one or more budget status reports 420 to customer 411. A given budget status report 420 may generally indicate whether/how well customer 411 has followed his/her budget through a particular point in time during the international trip. For example, budget status report 420 may indicate an amount by which actual expenditures over the course of the international trip are projected to exceed budgeted expenditures, or vice versa. Service application provision framework 308 may determine such a projected amount based on the actual expenditures made through the time of the budget status report 420. In an example embodiment, service application provision framework 308 may calculate the actual expenditures made per unit time from the start of the international trip through the time of the budget status report 420, multiply that figure by the duration of the international trip to project the total actual expenditures that will be made over the course of the international trip, and identify a projected budget shortfall or surplus based on the difference between the total actual expenditures and the total budgeted expenditures. In some embodiments, service application provision framework 308 may also consider the amounts of budgeted expenditures between the start of the international trip and the time of the budget status report 420. In an example embodiment, service application provision framework 308 may identify a percentage by which actual expenditures exceed or trail budgeted expenditures through the time of the budget status report 420, and may determine a projected budget shortfall or surplus based on the identified percentage and the total budgeted expenditures for the international trip. The embodiments are not limited to these examples.

Any given budget status report 420 may be constructed based on information comprised in travel budgeting record 418. In some embodiments, service application provision framework 308 may generate budget status information based on travel budgeting record 418 and construct budget status report 420 based on that budget status information. Such budget status information may generally comprise status information reflective of the manner in which the health of the budget is affected by the current state of factors/variables that have the potential to vary over time. For example, in some embodiments, service application provision framework 308 may generate budget status information based on travel budgeting record 418 and a currently-applicable exchange rate for exchanging the borrowed currency for an expended currency. In another example, in some embodiments, service application provision framework 308 may generate budget status information based on travel budgeting record 418 and location information indicating a current geographical location of customer 411. The embodiments are not limited to these examples.

Over the course of the international trip, service application provision framework 308 may send one or more activity recommendations 421 to customer 411. A given activity recommendation 421 may generally comprise information identifying recommendations relating to various aspects of activities in which customer 411 may engage during the international trip. For example, a given activity recommendation 421 may identify one or more recommended restaurants, hotels, museums, stores, bars, night clubs, tourist attractions, or venues of another type in a city/geographic region in which customer 411 is located or which customer 411 will subsequently visit during the international trip. In some embodiments, a given activity recommendation 421 may identify times of day during which one or more particular activities are—or are not—recommended in a city/geographic region in which customer 411 is located or which customer 411 will subsequently visit during the international trip. For example, a given activity recommendation 421 may identify recommended times of day during which to visit a museum and/or recommended times of day during which to avoid the museum. In some embodiments, a given activity recommendation 421 may identify routes and/or modes of transportation recommended for use in traveling to one or more points of interest in a city/geographic region in which customer 411 is located or which customer 411 will subsequently visit during the international trip. For example, a given activity recommendation 421 may indicate a recommendation that travel to a particular tourist attraction be performed via bus, and may identify a particular bus route to be used. The embodiments are not limited to these examples.

In some embodiments, service application provision framework 308 may consider the status of customer 411's travel budget in conjunction with generating a given activity recommendation 421. The recommendations provided to customer 411 may, in some cases, depend on whether actual expenditures to-date are over or under budget. For example, if actual expenditures are significantly over budget, service application provision framework 308 may use a given activity recommendation 421 to recommend one or more low priced restaurants at which customer 411 could dine in order to save money. Likewise, if actual expenditures are significantly under budget, service application provision framework 308 may use a given activity recommendation 421 to recommend one or more high-end restaurants at which customer 411 could dine if customer 411 wished to use the budget surplus to “splurge” for an exceptional dining experience. In another example, service application provision framework 308 may use a given activity recommendation 421 to recommend traveling to a tourist attraction via subway if actual expenditures are over budget, but to recommend traveling to the tourist attraction via taxi if actual expenditures are under budget. The embodiments are not limited to these examples.

Operations for the above embodiments may be further described with reference to the following figures and accompanying examples. Some of the figures may include a logic flow. Although such figures presented herein may include a particular logic flow, it can be appreciated that the logic flow merely provides an example of how the general functionality as described herein can be implemented. Further, the given logic flow does not necessarily have to be executed in the order presented unless otherwise indicated. In addition, the given logic flow may be implemented by a hardware element, a software element executed by a processor element, or any combination thereof. The embodiments are not limited in this context.

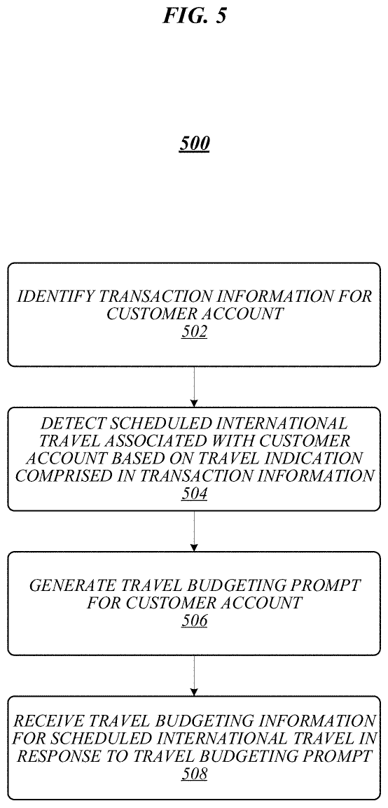

FIG. 5 illustrates one embodiment of a logic flow 500, which may be representative of operations that may be performed in conjunction with one or more of the disclosed techniques according to some embodiments. As shown in FIG. 5, transaction information for a customer account may be identified at 502. For example, in operating environment 400 of FIG. 4, transaction information 402 may be identified for a customer account associated with customer 411. At 504, scheduled international travel associated with the customer account may be detected based on a travel indication comprised in the identified transaction information. For example, in operating environment 400 of FIG. 4, an international trip planned by customer 411 may be detected based on a travel indication 412 comprised in transaction information 402 for a customer account associated with customer 411.

At 506, a travel budgeting prompt may be generated for the customer account in response to detection of the scheduled international travel. For example, in operating environment 400 of FIG. 4, a travel budgeting prompt 413 may be generated for a customer account associated with customer 411 following detection of a planned international trip based on a travel indication 412. At 508, travel budgeting information for the scheduled international travel may be received in response to the travel budgeting prompt. For example, in operating environment 400 of FIG. 4, travel budgeting information 414 may be received in response to a travel budgeting prompt 413 generated for a customer account associated with customer 411. The embodiments are not limited to these examples.

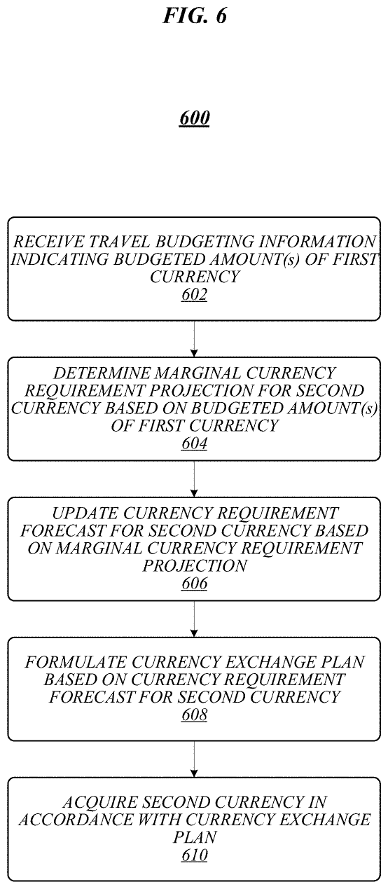

FIG. 6 illustrates one embodiment of a logic flow 600, which may be representative of operations that may be performed in conjunction with one or more of the disclosed techniques according to various embodiments. As shown in FIG. 6, travel budgeting information may be received at 602 that indicates one or more budgeted amounts of a first currency. For example, in operating environment 400 of FIG. 4, service application provision framework 308 may receive travel budgeting information 414 that indicates one or more budgeted amounts of a first currency. At 604, a marginal currency requirement projection for a second currency may be determined based on the one or more budgeted amounts of a first currency. For example, in operating environment 400 of FIG. 4, currency exchange management framework 206 may determine a marginal currency requirement projection 415 for a second currency based on one or more budgeted amounts of a first currency as indicated by travel budgeting information 414.

At 606, a currency requirement forecast for the second currency may be updated based on the marginal currency requirement projection for the second currency. For example, in operating environment 400 of FIG. 4, currency exchange management framework 206 may update a currency requirement forecast 416 for the second currency based on a marginal currency requirement projection 415 for the second currency. At 608, a currency exchange plan may be formulated based on the currency requirement forecast for the second currency. For example, in operating environment 400 of FIG. 4, currency exchange management framework 206 may formulate a currency exchange plan 417 based on a currency requirement forecast 416 for the second currency. At 610, the second currency may be acquired in accordance with the currency exchange plan. For example, in operating environment 400 of FIG. 4, currency exchange management framework 206 may initiate one or more currency exchange transactions in order to acquire the second currency in accordance with currency exchange plan 417. The embodiments are not limited to these examples.

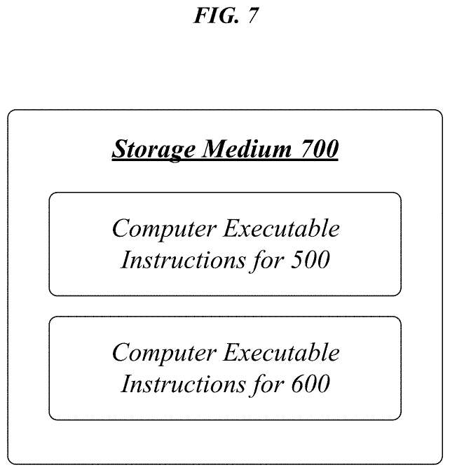

FIG. 7 illustrates an embodiment of a storage medium 700. Storage medium 700 may comprise any non-transitory computer-readable storage medium or machine-readable storage medium, such as an optical, magnetic or semiconductor storage medium. In various embodiments, storage medium 700 may comprise an article of manufacture. In some embodiments, storage medium 700 may store computer-executable instructions, such as computer-executable instructions to implement one or both of logic flow 500 of FIG. 5 and logic flow 600 of FIG. 6. Examples of a computer-readable storage medium or machine-readable storage medium may include any tangible media capable of storing electronic data, including volatile memory or non-volatile memory, removable or non-removable memory, erasable or non-erasable memory, writeable or re-writeable memory, and so forth. Examples of computer-executable instructions may include any suitable type of code, such as source code, compiled code, interpreted code, executable code, static code, dynamic code, object-oriented code, visual code, and the like. The embodiments are not limited in this context.

As used herein, the term “circuitry” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality. In some embodiments, the circuitry may be implemented in, or functions associated with the circuitry may be implemented by, one or more software or firmware modules. In some embodiments, circuitry may include logic, at least partially operable in hardware. Embodiments described herein may be implemented into a system using any suitably configured hardware and/or software.

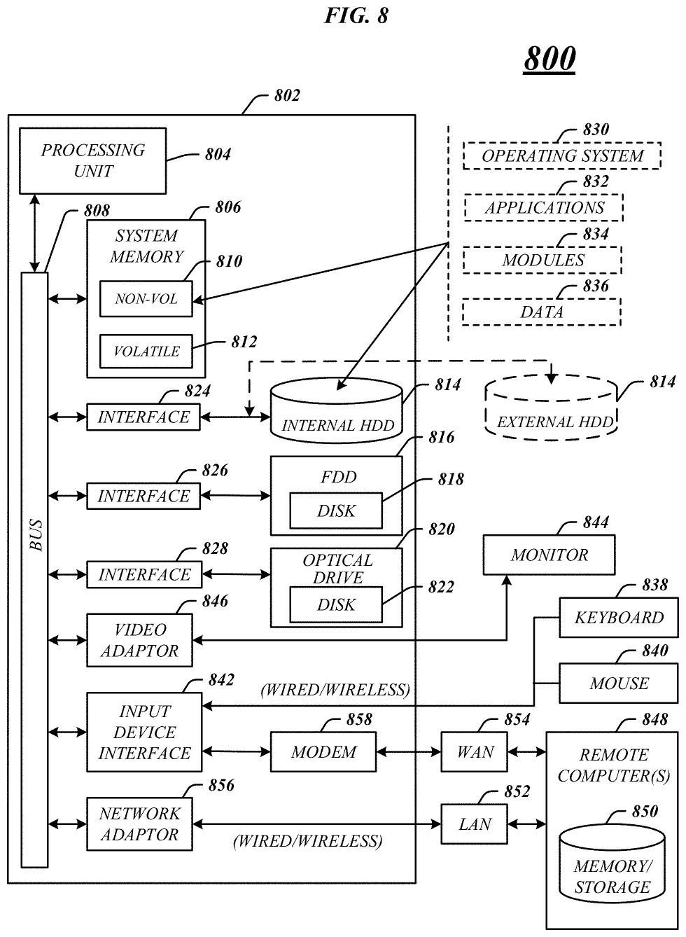

FIG. 8 illustrates an embodiment of an exemplary computing architecture 800 that may be suitable for implementing an apparatus, system, and/or method for performing operations associated with implementation of one or more of the disclosed techniques. In various embodiments, the computing architecture 800 may comprise or be implemented as part of an electronic device. In some embodiments, the computing architecture 800 may be representative, for example, of a server that implements one or more of transaction processing framework 104, currency exchange management framework 206, customer service framework 307, and service application provision framework 308. The embodiments are not limited in this context.

As used in this application, the terms “system” and “component” and “module” are intended to refer to a computer-related entity, either hardware, a combination of hardware and software, software, or software in execution, examples of which are provided by the exemplary computing architecture 800. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 800 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 800.

As shown in FIG. 8, the computing architecture 800 comprises a processing unit 804, a system memory 806 and a system bus 808. The processing unit 804 can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Celeron®, Core (2) Duo®, Itanium®, Pentium®, Xeon®, and XScale® processors; and similar processors. Dual microprocessors, multi-core processors, and other multi-processor architectures may also be employed as the processing unit 804. In some embodiments, processing circuitry of processing unit 804 and/or other processing circuitry of computing architecture 800 may be operative to perform operations associated with logic flow 500 and/or logic flow 600, and/or other operations associated with implementation of one or more of the disclosed techniques. In some embodiments, such processing circuitry may be coupled to a network interface of computing architecture 800.

The system bus 808 provides an interface for system components including, but not limited to, the system memory 806 to the processing unit 804. The system bus 808 can be any of several types of bus structure that may further interconnect to a memory bus (with or without a memory controller), a peripheral bus, and a local bus using any of a variety of commercially available bus architectures. Interface adapters may connect to the system bus 808 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The system memory 806 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 8, the system memory 806 can include non-volatile memory 810 and/or volatile memory 812. A basic input/output system (BIOS) can be stored in the non-volatile memory 810.

The computer 802 may include various types of computer-readable storage media in the form of one or more lower speed memory units, including an internal (or external) hard disk drive (HDD) 814, a magnetic floppy disk drive (FDD) 816 to read from or write to a removable magnetic disk 818, and an optical disk drive 820 to read from or write to a removable optical disk 822 (e.g., a CD-ROM or DVD). The HDD 814, FDD 816 and optical disk drive 820 can be connected to the system bus 808 by a HDD interface 824, an FDD interface 826 and an optical drive interface 828, respectively. The HDD interface 824 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 810, 812, including an operating system 830, one or more application programs 832, other program modules 834, and program data 836.

A user can enter commands and information into the computer 802 through one or more wire/wireless input devices, for example, a keyboard 838 and a pointing device, such as a mouse 840. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processing unit 804 through an input device interface 842 that is coupled to the system bus 808, but can be connected by other interfaces such as a parallel port, IEEE 1394 serial port, a game port, a USB port, an IR interface, and so forth.

A monitor 844 or other type of display device is also connected to the system bus 808 via an interface, such as a video adaptor 846. The monitor 844 may be internal or external to the computer 802. In addition to the monitor 844, a computer typically includes other peripheral output devices, such as speakers, printers, and so forth.

The computer 802 may operate in a networked environment using logical connections via wire and/or wireless communications to one or more remote computers, such as a remote computer 848. The remote computer 848 can be a workstation, a server computer, a router, a personal computer, portable computer, microprocessor-based entertainment appliance, a peer device or other common network node, and typically includes many or all of the elements described relative to the computer 802, although, for purposes of brevity, only a memory/storage device 850 is illustrated. The logical connections depicted include wire/wireless connectivity to a local area network (LAN) 852 and/or larger networks, for example, a wide area network (WAN) 854. Such LAN and WAN networking environments are commonplace in offices and companies, and facilitate enterprise-wide computer networks, such as intranets, all of which may connect to a global communications network, for example, the Internet.

When used in a LAN networking environment, the computer 802 is connected to the LAN 852 through a wire and/or wireless communication network interface or adaptor 856. The adaptor 856 can facilitate wire and/or wireless communications to the LAN 852, which may also include a wireless access point disposed thereon for communicating with the wireless functionality of the adaptor 856.

When used in a WAN networking environment, the computer 802 can include a modem 858, or is connected to a communications server on the WAN 854, or has other means for establishing communications over the WAN 854, such as by way of the Internet. The modem 858, which can be internal or external and a wire and/or wireless device, connects to the system bus 808 via the input device interface 842. In a networked environment, program modules depicted relative to the computer 802, or portions thereof, can be stored in the remote memory/storage device 850. It will be appreciated that the network connections shown are exemplary and other means of establishing a communications link between the computers can be used.

The computer 802 is operable to communicate with wire and wireless devices or entities using the IEEE 802 family of standards, such as wireless devices operatively disposed in wireless communication (e.g., IEEE 802.16 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.11x (a, b, g, n, etc.) to provide secure, reliable, fast wireless connectivity. A Wi-Fi network can be used to connect computers to each other, to the Internet, and to wire networks (which use IEEE 802.3-related media and functions).

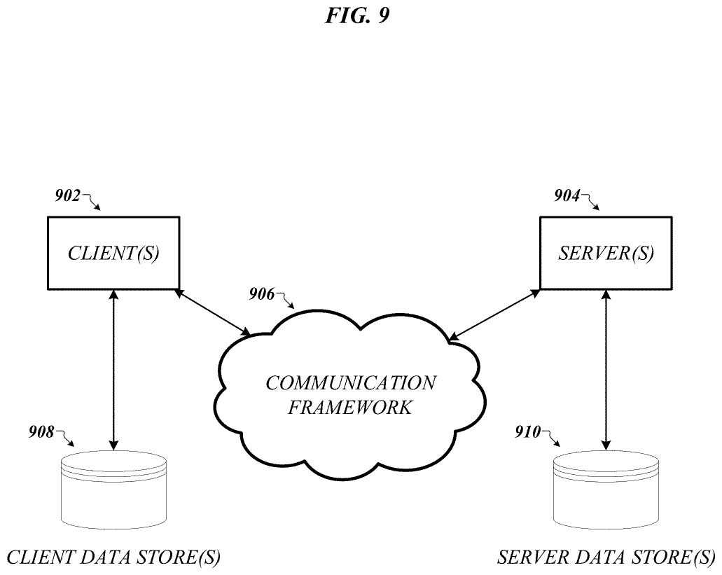

FIG. 9 illustrates a block diagram of an exemplary communications architecture 900 that may be suitable for implementing various embodiments as previously described. The communications architecture 900 includes various common communications elements, such as a transmitter, receiver, transceiver, radio, network interface, baseband processor, antenna, amplifiers, filters, power supplies, and so forth. The embodiments, however, are not limited to implementation by the communications architecture 900.

As shown in FIG. 9, the communications architecture 900 comprises includes one or more clients 902 and servers 904. The clients 902 and the servers 904 are operatively connected to one or more respective client data stores 908 and server data stores 910 that can be employed to store information local to the respective clients 902 and servers 904, such as cookies and/or associated contextual information.

The clients 902 and the servers 904 may communicate information between each other using a communication framework 906. The communications framework 906 may implement any well-known communications techniques and protocols. The communications framework 906 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communications framework 906 may implement various network interfaces arranged to accept, communicate, and connect to a communications network. A network interface may be regarded as a specialized form of an input output interface. Network interfaces may employ connection protocols including without limitation direct connect, Ethernet (e.g., thick, thin, twisted pair 10/100/1000 Base T, and the like), token ring, wireless network interfaces, cellular network interfaces, IEEE 802.11a-x network interfaces, IEEE 802.16 network interfaces, IEEE 802.20 network interfaces, and the like. Further, multiple network interfaces may be used to engage with various communications network types. For example, multiple network interfaces may be employed to allow for the communication over broadcast, multicast, and unicast networks. Should processing requirements dictate a greater amount speed and capacity, distributed network controller architectures may similarly be employed to pool, load balance, and otherwise increase the communicative bandwidth required by clients 902 and the servers 904. A communications network may be any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

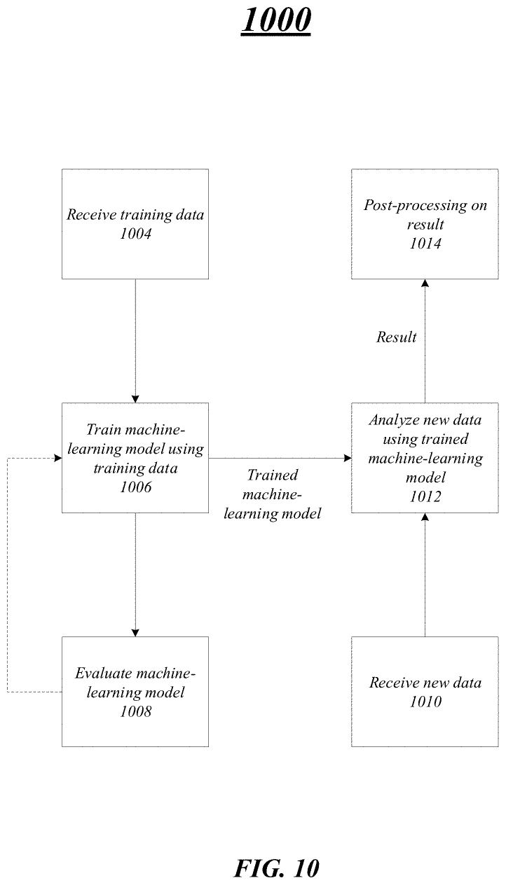

FIG. 10 is a flow chart of an example of a process 1000 for generating and using a machine-learning model according to some aspects. Machine learning is a branch of artificial intelligence that relates to mathematical models that can learn from, categorize, and make predictions about data. Such mathematical models, which can be referred to as machine-learning models, can classify input data among two or more classes; cluster input data among two or more groups; predict a result based on input data; identify patterns or trends in input data; identify a distribution of input data in a space; or any combination of these. Examples of machine-learning models can include (i) neural networks; (ii) decision trees, such as classification trees and regression trees; (iii) classifiers, such as Naïve bias classifiers, logistic regression classifiers, ridge regression classifiers, random forest classifiers, least absolute shrinkage and selector (LASSO) classifiers, and support vector machines; (iv) clusterers, such as k-means clusterers, mean-shift clusterers, and spectral clusterers; (v) factorizers, such as factorization machines, principal component analyzers and kernel principal component analyzers; and (vi) ensembles or other combinations of machine-learning models. In some examples, neural networks can include deep neural networks, feed-forward neural networks, recurrent neural networks, convolutional neural networks, radial basis function (RBF) neural networks, echo state neural networks, long short-term memory neural networks, bi-directional recurrent neural networks, gated neural networks, hierarchical recurrent neural networks, stochastic neural networks, modular neural networks, spiking neural networks, dynamic neural networks, cascading neural networks, neuro-fuzzy neural networks, or any combination of these.

Different machine-learning models may be used interchangeably to perform a task. Examples of tasks that can be performed at least partially using machine-learning models include various types of scoring; bioinformatics; cheminformatics; software engineering; fraud detection; customer segmentation; generating online recommendations; adaptive websites; determining customer lifetime value; search engines; placing advertisements in real time or near real time; classifying DNA sequences; affective computing; performing natural language processing and understanding; object recognition and computer vision; robotic locomotion; playing games; optimization and metaheuristics; detecting network intrusions; medical diagnosis and monitoring; or predicting when an asset, such as a machine, will need maintenance.

Machine-learning models can be constructed through an at least partially automated (e.g., with little or no human involvement) process called training. During training, input data can be iteratively supplied to a machine-learning model to enable the machine-learning model to identify patterns related to the input data or to identify relationships between the input data and output data. With training, the machine-learning model can be transformed from an untrained state to a trained state. Input data can be split into one or more training sets and one or more validation sets, and the training process may be repeated multiple times. The splitting may follow a k-fold cross-validation rule, a leave-one-out-rule, a leave-p-out rule, or a holdout rule. The training may also incorporate a clustering technique to cluster or classify data into groups, e.g., customers with similar profiles. An overview of training and using a machine-learning model is described below with respect to the flow chart of FIG. 10.

In block 1004, training data is received. In some examples, the training data is received from a remote database or a local database, constructed from various subsets of data, or input by a user. The training data can be used in its raw form for training a machine-learning model or pre-processed into another form, which can then be used for training the machine-learning model. For example, the raw form of the training data can be smoothed, truncated, aggregated, clustered, or otherwise manipulated into another form, which can then be used for training the machine-learning model. In embodiments, the training data may include historical data based on travel of previous customers or travelers. For example, the historical data may include information such as, length of travel, date of travel, location of travel, type of travel and so forth. The historical data may also include the profile of the previous customers/travelers. This information may be used to train the models to predict future expenditures, for example. Embodiments are not limited in this manner.

In block 1006, a machine-learning model is trained using the training data. The machine-learning model can be trained in a supervised, unsupervised, or semi-supervised manner. In supervised training, each input in the training data is correlated to a desired output. This desired output may be a scalar, a vector, or a different type of data structure. This may enable the machine-learning model to learn a mapping between the inputs and desired outputs. In unsupervised training, the training data includes inputs, but not desired outputs, so that the machine-learning model must find structure in the inputs on its own. In semi-supervised training, only some of the inputs in the training data are correlated to desired outputs.

In block 1008, the machine-learning model is evaluated. For example, an evaluation dataset can be obtained, for example, via user input or from a database. The evaluation dataset can include inputs correlated to desired outputs. The inputs can be provided to the machine-learning model and the outputs from the machine-learning model can be compared to the desired outputs. If the outputs from the machine-learning model closely correspond with the desired outputs, the machine-learning model may have a high degree of accuracy. For example, if 90% or more of the outputs from the machine-learning model are the same as the desired outputs in the evaluation dataset, e.g., the current transaction information, the machine-learning model may have a high degree of accuracy. Otherwise, the machine-learning model may have a low degree of accuracy. The 90% number is an example only. A realistic and desirable accuracy percentage is dependent on the problem and the data.

In some examples, if the machine-learning model has an inadequate degree of accuracy for a particular task, the process can return to block 1006, where the machine-learning model can be further trained using additional training data or otherwise modified to improve accuracy. If the machine-learning model has an adequate degree of accuracy for the particular task, e.g., predicting future expenditures, the process can continue to block 1010.

In block 1010, new data is received. In some examples, the new data is received from a remote database or a local database, constructed from various subsets of data, or input by a user. The new data may be unknown to the machine-learning model. For example, the machine-learning model may not have previously processed or analyzed the new data. In one example, the new data may be received from a customer 411 and/or from a system having profile information about the customer 411. The new data may include information about the customer's 411 travel plans and the profile may include information specific to the customer 411, as previously discussed.

In block 1012, the trained machine-learning model is used to analyze the new data and provide a result, estimated expenditures. For example, the new data can be provided as input to the trained machine-learning model. The trained machine-learning model can analyze the new data and provide a result that includes a classification of the new data into a particular class, a clustering of the new data into a particular group, a prediction based on the new data, or any combination of these.

In block 1014, the result is post-processed. For example, the result can be added to, multiplied with, or otherwise combined with other data as part of a job. As another example, the result can be transformed from a first format, such as a time series format, into another format, such as a count series format. Any number and combination of operations can be performed on the result during post-processing.

Numerous specific details have been set forth herein to provide a thorough understanding of the embodiments. It will be understood by those skilled in the art, however, that the embodiments may be practiced without these specific details. In other instances, well-known operations, components, and circuits have not been described in detail so as not to obscure the embodiments. It can be appreciated that the specific structural and functional details disclosed herein may be representative and do not necessarily limit the scope of the embodiments.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

It should be noted that the methods described herein do not have to be executed in the order described, or in any particular order. Moreover, various activities described with respect to the methods identified herein can be executed in serial or parallel fashion.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. It is to be understood that the above description has been made in an illustrative fashion, and not a restrictive one. Combinations of the above embodiments, and other embodiments not specifically described herein will be apparent to those of skill in the art upon reviewing the above description. Thus, the scope of various embodiments includes any other applications in which the above compositions, structures, and methods are used.

It is emphasized that the Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, novel subject matter lies in less than all features of a single disclosed embodiment. Thus the following claims are hereby incorporated into the Detailed Description, with each claim standing on its own as a separate preferred embodiment. In the appended claims, the terms “including” and “in which” are used as the plain-English equivalents of the respective terms “comprising” and “wherein,” respectively. Moreover, the terms “first,” “second,” and “third,” etc. are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. An apparatus, comprising:
a network interface; and
processing circuitry coupled to the network interface, the processing circuitry to:
receive transaction information over the network interface, the transaction information indicating a purchase using a customer account for a good, a service, or combination thereof relating to scheduled international travel;
detect, the scheduled international travel from the transaction information;
generate, via a trained model, estimated expenditures for the scheduled international travel, the trained model trained with historical data for previous customers comprising length of travel, location of travel, type of travel, or a combination thereof;
generate a travel budgeting prompt for the customer account;
communicate, via the network interface, the travel budgeting prompt and the estimated expenditures to a computing device associated with the customer account;
receive, via the network interface, travel budgeting information for the scheduled international travel in response to the travel budgeting prompt, the travel budgeting information to indicate one or more budgeted amounts of a first currency and at least partially based on the estimated expenditures;
determine a marginal currency requirement projection for a second currency based on the one or more budgeted amounts of the first currency;
update a currency requirement forecast for the second currency based on the marginal currency requirement projection;
send, via the network interface, a budget status report to the computing device associated with the customer account during the scheduled international travel;
detect an expenditure associated with the customer account during the scheduled international travel, the expenditure in the second currency;
update a travel budgeting record for the scheduled international travel based on the expenditure in the second currency;
determine one or more activity recommendations based on the expenditure and whether actual expenditures for the scheduled international travel are greater than the estimated expenditures, less than the estimated expenditures, or equal to the estimated expenditures; and
send, via the network interface and to the computing device, the one or more activity recommendations and an indication whether the actual expenditures are greater the estimated expenditures, less than the estimated expenditures, or equal to the estimated expenditures.

2. (canceled)

3. The apparatus of claim 1, the processing circuitry to:
generate budget status information based on the travel budgeting record and the applicable exchange rate for exchanging the first currency for the second currency; and
construct the budget status report based on the budget status information.

4. (canceled)

5. The apparatus of claim 1, the processing circuitry to:
formulate a currency exchange plan based on the currency requirement forecast for the second currency; and
acquire the second currency in accordance with the currency exchange plan.

6. The apparatus of claim 5, the currency exchange plan to define one or both of:
an exchange of the first currency for the second currency; and
an exchange of a third currency for the second currency.

7. A method, comprising:
generating, via a trained model, estimated expenditures for scheduled international travel, the trained model trained with historical data for previous customers comprising length of travel, location of travel, type of travel, or a combination thereof;
communicating, in response to detecting the scheduled international travel, a travel budgeting prompt and the estimated expenditures to a mobile device associated with a customer account;
receiving travel budgeting information for the scheduled international travel associated with the customer account, the travel budgeting information to indicate one or more budgeted amounts of a first currency and at least partially based on the estimated expenditures;
detecting, by processing circuitry, an expenditure associated with the customer account during the scheduled international travel, the expenditure occurring in a second currency;
updating a travel budgeting record for the scheduled international travel based on the expenditure;
generating budget status information based on the travel budgeting record and an applicable exchange rate for exchanging the first currency for the second currency;
sending a budget status report configured to present to the customer in the travel budgeting application on the mobile device during the scheduled international travel, the budget status report constructed based on the budget status information;
determining one or more activity recommendations based on the expenditure and whether actual expenditures for the scheduled international travel are greater than the estimated expenditures, less than the estimated expenditures, or equal to the estimated expenditures; and
sending one or more activity recommendations to the mobile device configured to present to the customer in the travel budgeting application on the mobile device associated with the customer account based on the travel budgeting record and the applicable exchange rate for exchanging the first currency for the second currency.

8. (canceled)

9. The method of claim 7, comprising:
determining a marginal currency requirement projection for the second currency based on the travel budgeting information for the scheduled international travel; and
updating a currency requirement forecast for the second currency based on the marginal currency requirement projection.

10. The method of claim 9, comprising formulating a currency exchange plan based on the currency requirement forecast for the second currency.

11. The method of claim 10, the currency exchange plan to define an exchange of the first currency for the second currency.

12. The method of claim 10, the currency exchange plan to define an exchange of a third currency for the second currency.

13. The method of claim 7, comprising:
detecting the scheduled international travel associated with the customer account based on a travel indication comprised in transaction information for the customer account;
generating the travel budgeting prompt for the customer account; and
receiving the travel budgeting information for the scheduled international travel in response to the travel budgeting prompt.

14-21. (canceled)

22. A non-transitory computer-readable storage media having stored thereon instructions that, when executed by processing circuitry of a computing system, cause the computing system to:
receive transaction information over the network interface, the transaction information indicating a purchase using a customer account for a good, a service, or combination thereof relating to scheduled international travel;
detect the scheduled international travel from the transaction information;
generate, via a trained model, estimated expenditures for the scheduled international travel, the trained model trained with historical data for previous customers comprising length of travel, location of travel, type of travel, or a combination thereof;
generate a travel budgeting prompt for the customer account;
communicate, via the network interface, the travel budgeting prompt and the estimated expenditures to a computing device associated with the customer account;
receive, via the network interface, travel budgeting information for the scheduled international travel in response to the travel budgeting prompt, the travel budgeting information to indicate one or more budgeted amounts of a first currency and at least partially based on the estimated expenditures;
determine a marginal currency requirement projection for a second currency based on the one or more budgeted amounts of the first currency;
update a currency requirement forecast for the second currency based on the marginal currency requirement projection;
send, via the network interface, a budget status report to the computing device associated with the customer account during the scheduled international travel;
detect an expenditure associated with the customer account during the scheduled international travel, the expenditure in the second currency;
update a travel budgeting record for the scheduled international travel based on the expenditure in the second currency;
determine one or more activity recommendations based on the expenditure and whether actual expenditures for the scheduled international travel are greater than the estimated expenditures, less than the estimated expenditures, or equal to the estimated expenditures; and
send, via the network interface and to the computing device, the one or more activity recommendations and an indication whether the actual expenditures are greater the estimated expenditures, less than the estimated expenditures, or equal to the estimated expenditures.

23. The non-transitory computer-readable storage media of claim 22, having stored thereon instructions that, when executed by processing circuitry of the computing system, cause the computing system to:
generate budget status information based on the travel budgeting record and the applicable exchange rate for exchanging the first currency for the second currency; and
construct the budget status report based on the budget status information.

24. The non-transitory computer-readable storage media of claim 22, having stored thereon instructions that, when executed by processing circuitry of the computing system, cause the computing system to:
formulate a currency exchange plan based on the currency requirement forecast for the second currency; and
acquire the second currency in accordance with the currency exchange plan.

25. The non-transitory computer-readable storage media of claim 24, the currency exchange plan to define one or both of:
an exchange of the first currency for the second currency; and
an exchange of a third currency for the second currency.
